(19) United States
(12) Patent Application Publication
(10) Pub. No.: US 2014/0228194 A1
(43) Pub. Date: Aug. 14, 2014

(54) SYSTEMS AND METHODS FOR FORMING OPENINGS IN WATER SOLUBLE PACKETS

(71) Applicant: Multi-Pack Solutions, Mt. Prospect, IL (US)

(72) Inventors: Andreas Kepinski, Mt. Prospect, IL (US); Thomas McLenithan, Mt. Prospect, IL (US)

(73) Assignee: Multi-Pack Solutions, Mt. Prospect, IL (US)

(21) Appl. No.: 14/179,878

(22) Filed: Feb. 13, 2014

Related U.S. Application Data
(60) Provisional application No. 61/764,196, filed on Feb. 13, 2013.

(51) Int. Cl. B31B 1/14

(52) U.S. Cl. CPC B31B 1/14
USPC 493/227

(57) ABSTRACT

Systems and methods to form openings in water soluble packets are described. The system includes a packet forming assembly to form water soluble packets, and a laser to form one or more openings in the water soluble packets. The method includes forming openings in the water soluble packets with a laser. The openings permit air to escape from the packets. By allowing air to escape, the water soluble packets have improved packaging characteristics. The water soluble packets are packed more tightly with a product.

### CROSS REFERENCE TO RELATED APPLICATION

This application claims the benefit of U.S. Provisional Patent Application 61/764,196 filed Feb. 13, 2013, which is hereby incorporated by reference.

### FIELD OF INVENTION

The present invention relates to systems and methods for forming openings in water soluble packets involving the use of a laser.

### BACKGROUND OF INVENTION

Water soluble packets, also commonly referred to as pouches or sachets, provide a single dose of a product in one convenient unit. The water soluble packets include a water soluble film sealed around a pre-measured amount of the product. During exposure or contact with water, the film dissolves and the product mixes with the water. The water soluble packets provide many benefits to the consumer. The water soluble packets are pre-measured, and thus avoid any measuring by the consumer. The product is contained by the film, and it not prone to spilling.

The water soluble packets are commonly used with dishwasher and laundry detergents. During a wash cycle, the water soluble film dissolves when exposed to the wash liquid allowing the detergent to mix with the wash liquid. The water soluble packets may also be used in any of a variety of different applications and contain any of a variety of different products. For example, herbicides, fertilizers, lawn chemicals, rinse-aids, cleaners, etc. may all be sealed within the water soluble packets.

Conventional water soluble packets are formed by using a drum having rows of cavities on its exterior surface. A base or bottom layer of film, such as a polyvinyl alcohol (PVA) film, is applied over the cavities. A vacuum from inside of the drum draws the base layer of film into the cavities to form a receptacle to receive the product. A specified amount of the product is next metered onto the base layer of film. A lid or an upper layer of film, such as additional PVA film, is then sealed over the base layer of the film. The product is now sealed inside of a combination of the base layer and the lid layer of films. Rows and rows of water soluble packets are formed as part of a continuous process. As the drum rotates, individual water soluble packets are cut from the rows of water soluble packets. Such processes and equipment are described in U.S. Pat. No. 3,218,776, which is hereby incorporated by reference.

During the filling and sealing process, air becomes trapped inside of the packet with the product. The air forms an air bubble or an air pocket inside of the sealed water soluble packet. The air bubble or air pocket may cause inadvertent rupture of the water soluble packet and is not desirable from an aesthetic or packaging perspective.

In order to get the air out of packet, a water mist is typically sprayed onto the sealed water soluble packet by a mister. The water mist creates passages in the film of the water soluble packet to allow air trapped in the laundry packet to escape. Unfortunately, the water may also cause much of the film to discolor, which may not be cosmetically desirable from a consumer's or a retailer's perspective. Further, the water soluble packets may also become sticky and adhere to one another after being sprayed with the water mist. This causes problems in automated filling processes, which direct the water soluble packets into containers for retail sale. In these automated filling processes, the containers may be filled by weight, and multiple water soluble packets sticking together may interfere with such automated filling processes.

### SUMMARY OF INVENTION

Systems and methods for forming openings in water soluble packets involving the use of a laser are herein described. The laser forms the openings to vent the water soluble packets. The openings provide for the escape or release of air trapped in the water soluble packets. The laser also forms the openings to assist in the filling of the water soluble packet with detergent or other product. The laser burns openings into the water soluble film that forms the water soluble packet.

The openings provide a number of improvements in the manufacturing process for water soluble packets and the resulting water soluble packets. First, the laser openings do not discolor the entire film of the water soluble packet. Second, the laser openings do not make the water soluble packets sticky, which is a problem associated with the use of a conventional water mister. Further, the laser openings, when applied in a pre-fill stage, assist in forming the water soluble packet with several beneficial aesthetic features that may be more desirable to consumer. The product in such water soluble packets is more tightly packed with fewer wrinkles in the film as compared to conventional packets. Further, the water soluble packets formed using the laser processes described herein are not generally pliable and do not exhibit a loose feel common to conventional water soluble packets.

The openings may include holes, perforations, voids, vents, etc. in the film. The laser burns the openings in the films. The openings permit air to escape from the packets. During the manufacturing process, air may be trapped inside of the packet with the product. The openings provide for the trapped air to escape or vent. The air trapped in the water soluble packet is generally under pressure, and the openings allow the interior of the water soluble packet to equilibrate in pressure with the atmosphere. By allowing air to escape, the water soluble packet has improved packaging characteristics. The water soluble packets are packed more tightly with product. Further, the film does not have bubbles or loose folds of the film. Also, the packets are not sticky or mostly discolored. Further, the packets tend to have a uniform and consistent appearance. These characteristics may be desirable to a consumer or retailer.

The laser may be configured to form the openings at any of a variety of stages during the industrial manufacture of the water soluble packets. During the manufacturing process, the product is filled into cavities which are lined with a base layer of the film. The cavities are in the exterior surface of a rotating drum. After the filling, a lid layer of film is sealed to the base layer over the product.

The laser may form the openings at a pre-fill stage or at a post-fill stage in the manufacturing process of the water soluble packets. In a first pre-fill process, the laser forms the openings after the base film is positioned over or drawn into the cavities of the drum and before adding the product to the cavities. In a second pre-fill process, the laser forms the openings before the base film is positioned over the cavities. For example, the laser forms the openings in the base film as the base film is unrolled. In a third pre-fill process, the laser forms the openings in the lid film before the lid film is sealed to the base film. For example, the laser forms the openings in the lid film as the lid film is unrolled.

The laser may also form openings in the sealed packets of product, i.e., at a post-fill stage. For example, the laser may be positioned over an output or take away conveyor and direct pulses to the sealed packets.

The laser forms the openings as part of a continuous manufacturing process, i.e., the laser forms the openings while the film or water soluble packets are moving. Typically, the films or water soluble packets are not intermittently slowed or stopped in order to form the openings with the laser. As such, the use of the laser does not slow down production rates of the water soluble packets.

The laser may also be used with or integrated into both horizontal and vertical form fill seal machines.

In one aspect, a system to form openings in water soluble packets is described. The system includes a packet forming assembly to form water soluble packets. The packet forming assembly includes one or more cavities, a base film supply roll that supplies a base film to cover the one or more cavities, a feed hopper meters an amount of a product into the one or more cavities over the base film, and a lid film supply roll supplies a lid film that is sealed to the base film. A laser forms one or more openings in the water soluble packets.

In another aspect, a method of forming openings in water soluble packets is described. The method includes providing a packet forming assembly to form water soluble packets. The packet forming assembly comprises one or more cavities. The method includes covering the one or more cavities with a base film. The method includes feeding an amount of a product into the one or more cavities over the base film. The method includes sealing a lid film to the base film to form the water soluble packets. The method includes forming openings in the water soluble packets with a laser.

### BRIEF DESCRIPTION OF DRAWINGS

FIG. 1 is a schematic view of multiple configurations of the laser-assisted water soluble packet forming system.

FIG. 2 is a perspective view of the packet forming assembly.

FIG. 3 is a perspective view of the first configuration of the laser-assisted water soluble packet forming system.

FIG. 4 is a perspective view of the second configuration of the laser-assisted water soluble packet forming system.

FIG. 5 is a perspective view of the third configuration of the laser-assisted water soluble packet forming system.

FIG. 6 is a perspective view of the fourth configuration of the laser-assisted water soluble packet forming system.

FIG. 7 is a perspective view of the water soluble packet.

FIG. 8 is close-up view of the drum and its cavities.

FIG. 9 is a schematic view of the laser with a horizontal form fill seal machine.

FIG. 10 is a perspective view of the laser with a vertical form fill seal machine.

### DETAILED DESCRIPTION OF INVENTION

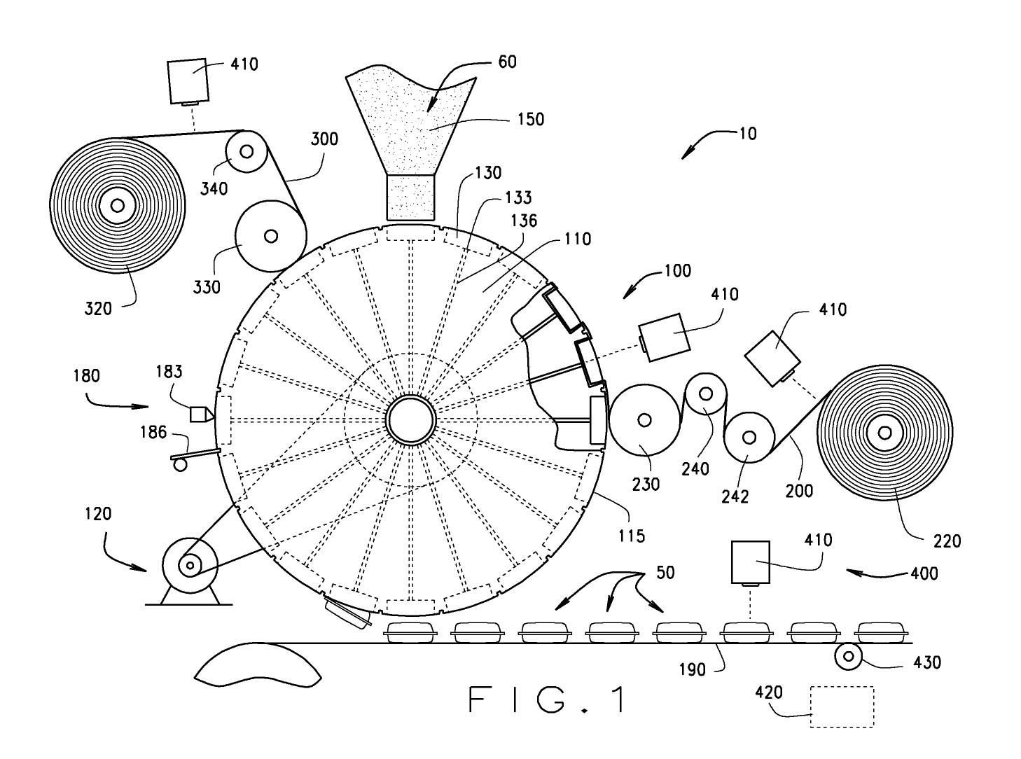

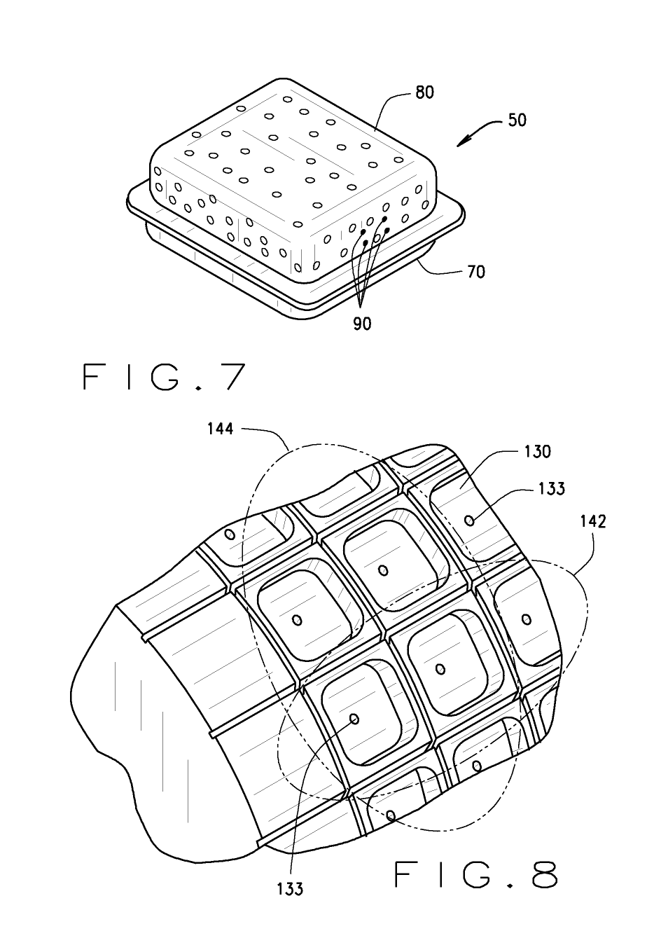

FIG. 1 is a schematic view of multiple configurations of a laser-assisted water soluble packet forming system 10, which is used to form water soluble packets 50. An example of the water soluble packet 50 is shown in FIG. 7. The system 10 forms openings 90 in the water soluble packets 50. The openings 90 are formed by a laser 410. As shown in FIG. 1, the laser 410 may be positioned at any of a number of different alternate positions about the system 10.

The water soluble packets 50 include a product 60 sealed between a base layer 70 and a lid layer 80. The base layer 70 is formed from a base film 200, while the lid layer 80 is formed from a lid film 300. The openings 90 include holes, perforations, voids, vents, etc. in either or both of the base layer 70 and the lid layer 80. As described below, the laser 410 may direct its pulses at any of the base film 200, the lid film 300, and/or the sealed water soluble packets 50. Depending upon the set-up, the laser 410 burns the openings 90 in any or all of the base layer 70, lid layer 80, base film 200, or lid film 300.

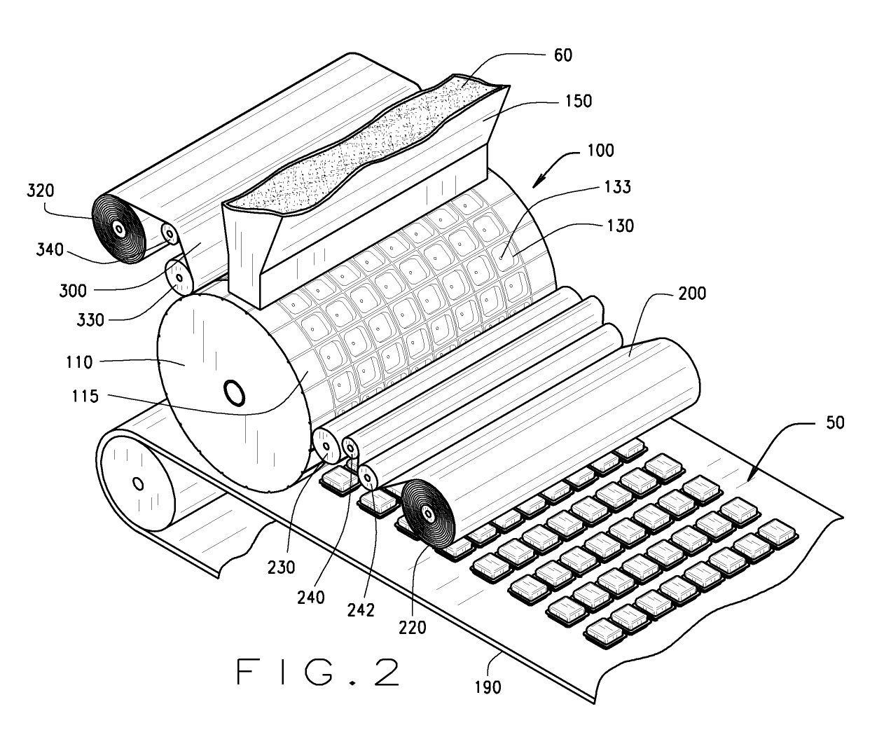

FIG. 2 is a perspective view of a packet forming assembly 100, which includes a rotating drum 110 operatively engaged to a motor 120 for rotation of the drum 110. The packet forming assembly 100 forms the water soluble packets 50. The drum 110 includes a plurality of cavities 130. A bulk amount of the product 60 is placed in a feed hopper 150, which is generally positioned above the drum 110. As the drum 110 rotates, the feed hopper 150 meters an amount of the product 60 into the cavities 130 on top of the base film 200. The lid film 300 is sealed to the base film 200, and the water soluble packets 50 are separated.

The base film 200 is directed to the drum 110 from the base film supply roll 220. A base film roller 230 presses the base film 200 against a surface 115 of the drum 110. The base film 200 generally covers a plurality of the cavities 130. Guide rollers 240 and 242 assist in directing and transferring the base film 200 to the drum 110.

The lid film 300 is directed to the drum 110 from the lid film supply roll 320. A lid film roller 330 presses the lid film 300 against the base film 200. A guide roller 340 assists in directing and transferring the lid film 300 to the drum 110.

The drum 110 includes multiple rows 142 of the cavities 130. Generally, the surface 115 of the drum 110 is covered with the cavities 130. The laser 410 may simultaneously pulse groups 144 of the cavities 130. The groups 144 may cover multiple rows 142 of the cavities 130.

With reference to FIGS. 1 and 8, each of the cavities 130 includes a vacuum opening 133 that is in fluidic communication with a vacuum passage 136. The packet forming assembly 100 draws a vacuum through the vacuum passage 136 and the vacuum opening 133.

With reference to FIG. 1, the packet forming assembly 100 includes a cutting assembly 180 to separate the water soluble packets 50 from each other. The cutting assembly 180 may include a vertical cutter 183 to make vertical separation cuts and a horizontal cutter 186 to make horizontal separation cuts. After the water soluble packets 50 are separated, the drum 110 drops the water soluble packets 50 onto a take away conveyor 190.

With continued reference to FIG. 1, a laser assembly 400 includes the laser 410 to form the openings 90 in the water soluble packets 50. The laser assembly 400 also includes a controller 420 and an encoder 430. The controller 420 and the encoder 430 register and time the pulses from the laser 410 to strike the base layer 70, lid layer 80, base film 200, and/or the lid film 300 at the appropriate interval and time.

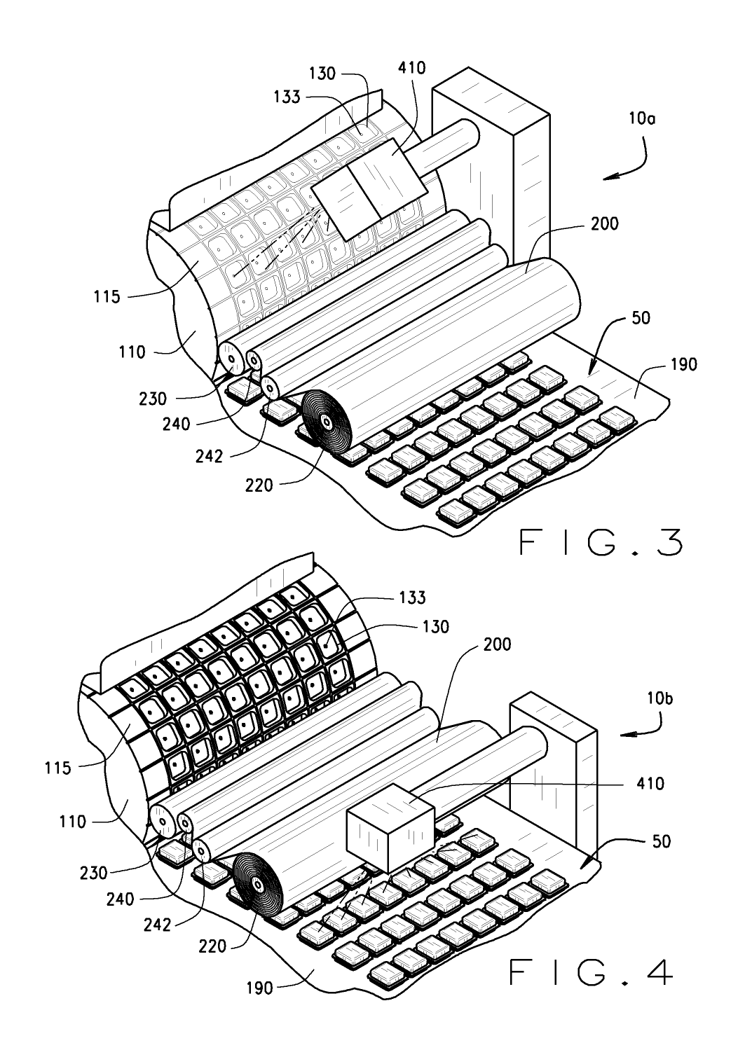

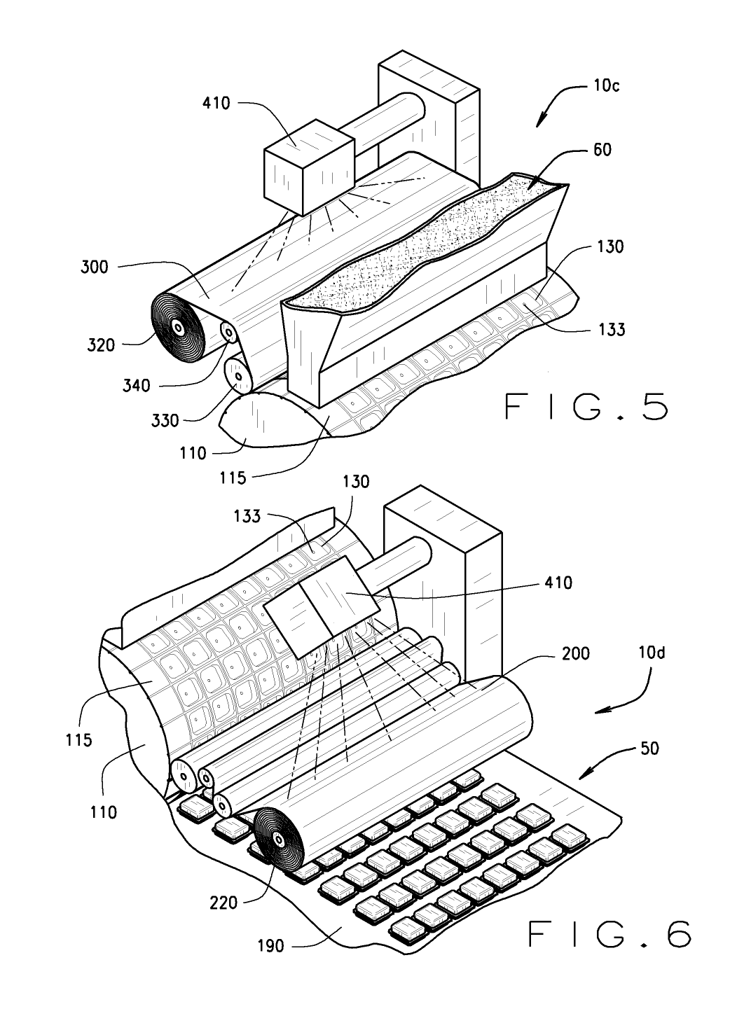

The laser 410 may be integrated with the packet forming assembly 100 in any of a variety of configurations or positions. As described below in greater detail, the laser 410 may form the openings 90, shown in FIG. 7, at a pre-fill stage or a post-fill stage in the packet forming process. Four exemplary configurations of the system 10 are described below and are referred to herein as configurations 10a, 10b, 10c, and 10d. Of course, one or more lasers 410 may be simultaneously employed at any of the configurations or positions. In summary, FIG. 3 shows a perspective view of the first configuration 10a of the system 10, which forms the openings 90 when the base film 200 is over or drawn into the cavities 130. FIG. 4 shows a perspective view of the second configuration 10b, which forms the openings 90 in the sealed water soluble packets 50 after the water soluble packets 50 are formed on the drum 110 and separated by the cutting assembly 180. FIG. 5 shows a perspective view of the third configuration 10c, which forms the openings 90 in the lid film 300 before the lid film 300 is sealed to the base film 200. FIG. 6 shows a perspective view of the fourth configuration 10d, which forms the openings 90 in the base film 200 before base film 200 reaches the drum 110.

With reference to FIG. 3, the first configuration 10a forms the openings 90 when the base film 200 is over or drawn into the cavities 130. The first configuration 10a forms the openings 90 at a pre-fill stage. The laser 410 may form openings 90 in the base film 200, while the base film 200 is positioned over the drum 110 or after the base film 200 has been drawn into the cavities 130 by the vacuum. In this aspect, the openings 90 are formed before the product 60 is added to the base film 200. The laser 410 is positioned proximate to the drum 110, and the laser 410 is focused toward the individual cavities 130 of the drum 110. The drum 110 provides the vacuum through the vacuum passage 136 that conforms the base film 200 to the drum 110 and into the individual cavities 130. Air is drawn into the vacuum passage 136 through the vacuum opening 133 in the bottom of the cavity 130. The vacuum draws and stretches the base film 200 into the individual cavities 130. The base film 200 forms a receptacle shape in the individual cavities 130 to receive the product 60. Before the product 60 is added to the base film 200 positioned in the cavities 130, the laser 410 forms the openings 90 in the base film 200. Notably, the openings 90 are formed by the laser 410 after the base film 200 has been stretched into the cavities 130 by the vacuum of the drum 110. The openings 90 are formed in the base film 200 after the base film 200 has been stretched, so the openings 90 will generally maintain their dimension as the base film 200 is not generally further stretched during the formation of the water soluble packet 50.

In this aspect, the vacuum is also drawing air through the openings 90 in the film, which sucks the product 60 into the base film 200. The product 60 may be deposited on the base film 200 in the cavities 130 while the vacuum force is drawing the base film 200 into the cavity 130 and air is passing through the openings 90 and into the vacuum opening 133. This assists in increasing the density of the product 60 within the packet 50. The product 60 in such water soluble packets 50 is more tightly packed with fewer wrinkles in the film as compared to conventional packets. Without the openings 90 and the drawing of air through the openings 90 by the vacuum, the water soluble packet 50 will have a softer feel and the product 60 will be more loosely contained in the water soluble packet 50.

With reference to FIG. 4, the second configuration 10b forms the openings 90 in the sealed water soluble packets 50 after the water soluble packets 50 are formed on the drum 110 and separated by the cutting assembly 180. The second configuration 10b forms the openings 90 at a post-fill stage. The laser 410 may be positioned to form openings 90 in the sealed water soluble packets 50 after the water soluble packets 50 are formed on the drum 110 and separated by a cutting assembly 180. In this aspect, the openings 90 are formed after the lid film 300 and base film 200 are sealed together to contain the product 60. The laser 410 may be positioned over the take away conveyor 190. The laser 410 may be focused on any portion of the water soluble packet 50.

With reference to FIG. 5, the third configuration 10c forms the openings 90 in the lid film 300 before the lid film 300 is sealed to the base film 200. The third configuration 10c also forms the openings 90 at the pre-fill stage. The laser 410 may form the openings 90 in the lid film 300 that forms the packet 50. The laser 410 may be positioned to form openings 90 in the lid film 300 before the lid film 300 reaches the drum 110. The laser 410 is positioned proximate to the lid film supply roll 320. As the sheet of the lid film 300 is unrolled and directed to the drum 110, the laser 410 may form the openings 90. One or more lasers may be configured to intermittently form openings 90 in the entire width of lid film 300 used to cover the cavities 130. In this aspect, the openings 90 may be formed in portions of the lid film 300 which will become the sides or a periphery of the finished water soluble packet 50. These areas of the lid film 300 are subjected to less stretching than the areas of the base film 200, which will become the central portions of the water soluble packet 50. By forming the openings 90 at the sides or periphery, the openings 90 are not generally stretched during the sealing process, and the openings 90 maintain their desired shape.

With reference to FIG. 6, the fourth configuration 10d forms the openings 90 in the base film 200 before base film 200 reaches the drum 110. The fourth configuration 10d also forms the openings 90 at the pre-fill stage. The laser 410 may form openings 90 in the base film 200 that forms the packet 50. The laser 410 may be positioned to form openings 90 in the base film 200 before the base film 200 reaches the drum 110. The laser 410 is positioned proximate to the base film supply roll 220. As the sheet of the base film 200 is unrolled and directed to the drum 110, the laser 410 may form the openings 90. One or more lasers 410 may be configured to intermittently form openings 90 in the entire width of the base film 200 used to cover the cavities 130. In this aspect, the openings 90 are formed before the product 60 is added to the base film 200 and before the base film 200 and the lid film 300 are sealed together. The openings 90 may be formed in portions of the base film 200 which will become the sides or a periphery of the finished water soluble packet 50. These areas of the base film 200 are subjected to less stretching than the areas of the base film 200 film which will become the central portions of the water soluble packet 50. By forming the openings 90 at the sides or periphery, the openings 90 are not generally stretched during the filling process, and the openings 90 maintain their desired shape.

The laser 410 will now be described. The laser 410 forms one or more openings 90 in the water soluble packet 50 or the portion of the films 200 and 300 forming the water soluble packet 50. In some aspects, the laser 410 forms four openings 90 in each water soluble packet 50. The openings 90 may have various sizes and shapes. For example, the openings 90 may have a size up to approximately 1000 um.

The system 10, laser assembly 400, and/or the processes described herein may be incorporated into water soluble packet forming systems and equipment from Cloud Packaging Solutions of Des Plaines, Ill. Such equipment is commercially available under the tradename HYDRO-FORMA.

The laser 410 may be configured to provide enough power to generally only burn the openings 90 into the film, and, in post-fill applications, not to burn a significant amount of the product 60 therein. The pulses will not damage the cavities 130, belts, rollers, or other components of the water soluble packet forming system 10. Although the laser 410 will not hurt a worker with incidental, momentary exposure to the laser 410, the system 10 and its equipment may be provided with a protective shield and/or barriers to prevent accidental exposure of workers to the laser 410.

With reference to FIG. 1, the laser assembly 400 includes the laser 410 to form the openings 90 in the water soluble packets 50. The laser assembly 400 also includes the controller 420 and the encoder 430. Existing water soluble packet forming systems may be retrofitted to include the laser assembly 400. The laser 410 may be electronically linked to the controller 420, which registers the pulses from the laser 410 with the moving films 200 and/or 300 or moving water soluble packets 50. The encoder 430 may measure the speed of the take away conveyor 190, the drum 120, or any of the films 200 and 300. The encoder 430 is in electrical communication with the controller 420 to provide the controller 420 with data regarding the speed. The laser 410 may be positioned stationary with respect to the moving films 200 and/or 300 or the belts carrying the water soluble packets 50. The controller 420 may time the laser 410 to intermittently pulse the laser 410 as the films 200 and/or 300 or the water soluble packets 50 move past a focus point of the laser 410. The controller 420 may be electronically linked to sensors or additional encoders that monitor the movement of the film or the belt carrying the water soluble packets 50. The controller 420 times the pulses from the laser 410 to impact the films or water soluble packets 50 at the appropriate interval.

Any of a variety of lasers may be used with the system 10 and the processes described herein. One suitable laser for the laser 410 is a commercially available laser as Model 3320 from Videojet Technologies, Inc. of Wood Dale, Ill. This laser is a 30 watt CO2 laser.

The laser 410 and/or the controller 420 may be programmed to modulate any of a number of parameters and attributes of the laser pulses, for example, the timing of the laser pulses, the frequency of the laser pulses, the shape of the laser pulse, the pattern of the laser pulses, the area of coverage of the laser pulses, etc. The laser 410 and/or the controller 420 may include user-input controls, such as a touch screen, keyboard, etc.

The laser 410 may simultaneously emit an array of pulses that simultaneously forms multiple openings 90. For example, the laser 410 may be configured to simultaneously form openings 90 in the base film 200 covering multiple rows 142 and groups 144 of the cavities 130 of the drum 110. The laser 410 may be configured to simultaneously form openings 90 in multiple packets 50, multiple rows of packets 50, and/or or multiple groups 144 of packets 50. Likewise, the laser 410 may be configured to simultaneously form openings 90 across a web of the films 200 and 300 in multiple columns and rows. For example, in a post-fill process, the laser 410 may be configured to simultaneously form openings 90 in approximately 12 water soluble packets 50. For example, in a pre-fill process, the laser 410 may be configured to simultaneously form openings 90 across a portion of the films 200 and/or 300 of approximately 24 inches wide by approximately 0.25 to 1 inches deep. For example, in a pre-fill process, the laser 410 may be configured to simultaneously form openings 90 in a base film 200 covering approximately 12 cavities of the drum 110. Further, multiple lasers 410 may be used together to fully cover a width of the drum 110, films 200 and/or 300, or the take away conveyor 190.

The lid film 300 and base film 200 may be a water soluble film, such as a polyvinyl alcohol (PVA) film. The films dissolve with contact of water or other fluids. The films may have a thickness of approximately 1 millimeter to approximately 5 millimeter. Such films are commercially available from Monosol of Merrillville, Ind. Other water soluble films for forming the water soluble packets 50 may include any water-soluble, film-forming polymer, copolymer, or mixtures of such polymers. The polymers may include vinyl polymers, including homopolymers and copolymers, having functionality rendering the polymers water-soluble, such as hydroxyl and carboxyl groups. Typical water-soluble polymers include at least one of polyvinyl alcohol, partially hydrolyzed polyvinyl acetate, polyvinyl pyrrolidone, alkyl celluloses such as methylcellulose, ethylcellulose, propylcellulose and derivatives thereof, such as the ethers and esters of alkyl celluloses, and acrylic polymers such as water-soluble polyacrylates, polyacrylamides, and acrylic maleic anhydride copolymers. Suitable water-soluble polymers further include copolymers of hydrolyzed vinyl alcohol and a nonhydrolyzable anionic comonomer.

Although the methods, systems, and assemblies described above are described with respect to laundry and dishwashing water soluble packets, the methods, the system 10, and/or the laser assembly 400 may be used to form water soluble packets 50 containing any of a variety of products 60 such as, for example, powders, granules, or other solid compositions for any application, such as, for example, herbicides, fertilizers, lawn chemicals, rinse-aids, cleaners, etc. Generally, the water soluble packets 50 will contain a dry product 60.

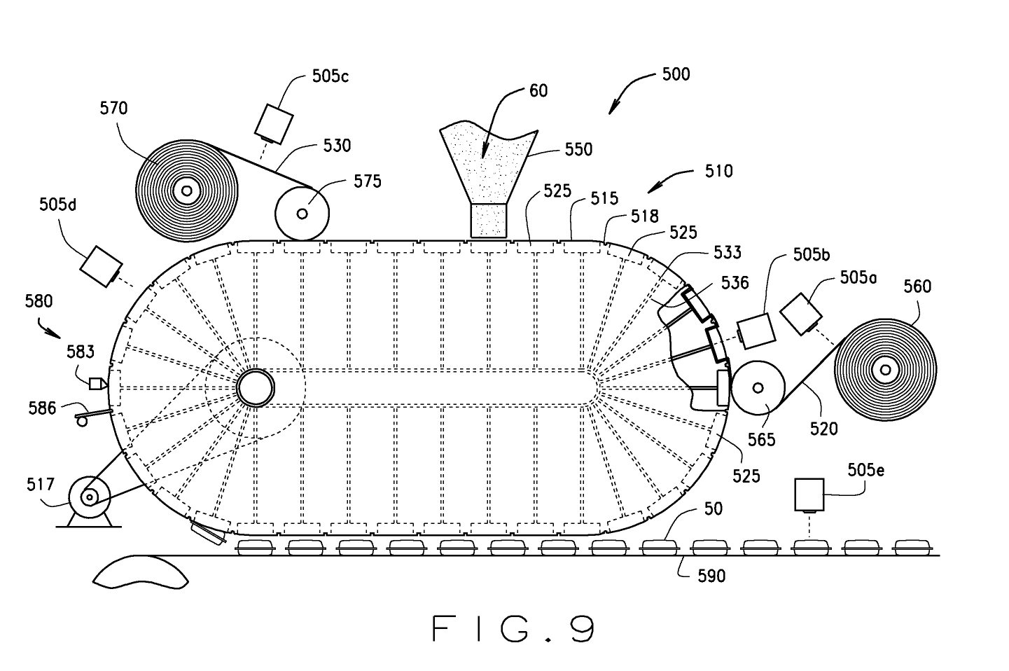

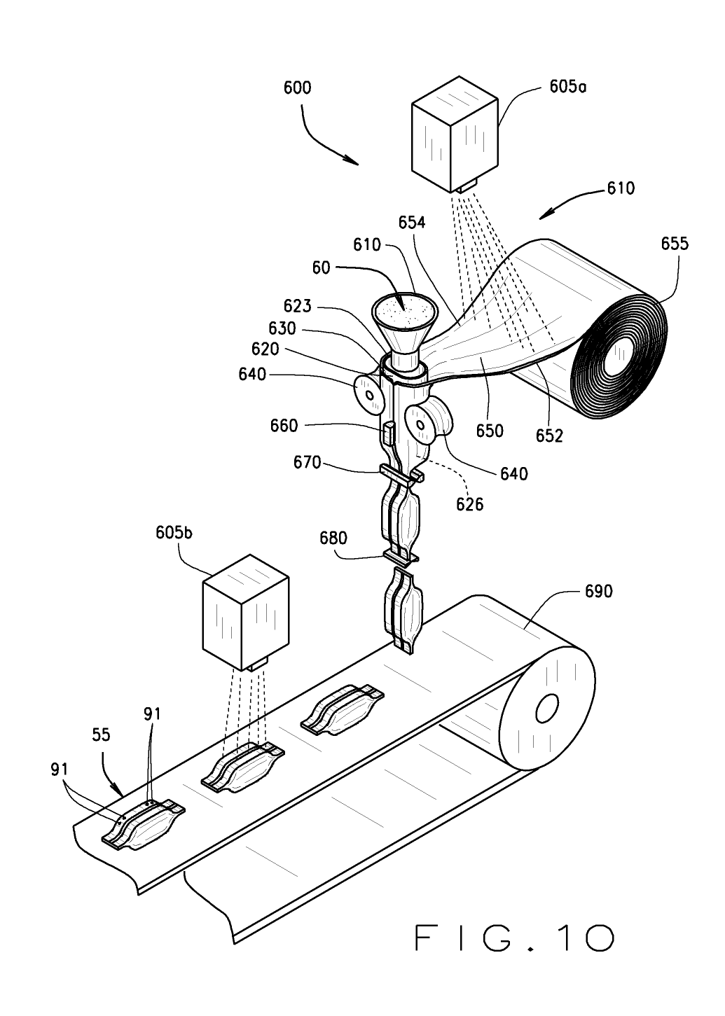

In addition to the packet forming assembly 100, one or more lasers may also be used with or integrated into horizontal form fill seal machines and/or vertical form fill seal machines in order form openings to vent the water soluble packets. Horizontal form fill seal machines and vertical form fill seal machines are also used to make water soluble packets. As with other aspects, the openings provide for the escape or release of air trapped in the water soluble packets. The laser also forms the openings to assist in the filling of the water soluble packet with detergent or other product. These aspects are shown in FIGS. 9 and 10.

FIG. 9 is a schematic view of a laser-assisted water soluble packet forming system 500 using one or more of lasers 505a, 505b, 505c, 505d, and 505e with a horizontal form fill seal machine 510. The system 500 includes an endless belt 515 operatively engaged to a motor 517 for movement of the endless belt 515. The packet forming assembly 500 also forms the water soluble packets 50. The endless belt 515 includes a plurality of cavities 525. A bulk amount of the product 60 is placed in a feed hopper 550, which is generally positioned above the endless belt 515. As the endless belt 515 moves, the feed hopper 550 meters an amount of the product 60 into the cavities 525 on top of a base film 520. A lid film 530 is sealed to the base film 520, and the water soluble packets 50 are separated. The base film 520 is directed to the endless belt 515 from a base film supply roll 560. A base film roller 565 presses the base film 520 against the endless belt 515. The lid film 530 is directed to the endless belt 515 from a lid film supply roll 570. A lid film roller 575 presses the lid film 530 against the base film 520. The endless belt 515 includes multiple rows of the cavities 525. Generally, a surface 518 of the endless belt 515 is covered with the cavities 525. The cavities 525 include a vacuum opening 533 that is in fluidic communication with a vacuum passage 536. The packet forming assembly 500 includes a cutting assembly 580 to separate the water soluble packets 50 from each other. The cutting assembly 580 may include a vertical cutter 583 to make vertical separation cuts and a horizontal cutter 586 to make horizontal separation cuts. After the water soluble packets 50 are separated, the endless belt 515 drops the water soluble packets 50 onto a take away conveyor 590.

The lasers 505a, 505b, 505c, 505d, and 505e may be integrated with the packet forming assembly 500 in any of a variety of configurations or positions. Although FIG. 9 shows the use of multiple lasers, only one of the lasers 505a, 505b, 505c, 505d, and 505e needs to be employed. The lasers 505a, 505b, 505c, 505d, and 505e may form the openings 90, shown in FIG. 7, at a pre-fill stage or a post-fill stage in the packet forming process. Of course, one or more of the lasers 505a, 505b, 505c, 505d, and 505e may be simultaneously employed at any of the configurations or positions. For example, the laser 505a may form the openings 90 in the base film 520 before the base film 520 reaches the endless belt 515. The laser 505b may form the openings 90 when the base film 520 is over or drawn into the cavities 525. The laser 505c may form the openings 90 in the lid film 530 before the lid film 530 is sealed to the base film 520. The laser 505d may form the openings 90 after the water soluble packets 50 are formed on the endless belt 515 but before the packets 50 are separated by the cutting assembly 580. The laser 505e may form the openings 90 after the water soluble packets 50 are formed on the endless belt 515, separated by the cutting assembly 580, and deposited on the take away conveyor 590. The laser 505e may be positioned directly over the take away conveyor 590.

FIG. 10 is a perspective view of a laser-assisted water soluble packet forming system 600 using one or both of lasers 605a and 605b with a vertical form fill seal machine 610. The packet forming assembly 600 generally forms water soluble packets 55 from a single layer of a film 650. A bulk amount of the product 60 is placed in a feed hopper 610, which is generally positioned above a horn 620. The horn 620 includes an entrance opening 623 and an exit opening 626. The horn 620 also includes an exterior surface 630. Drive rollers 640 pull the film 650 over the exterior surface 630 while the product 60 is metered into an interior of the horn 620 through the entrance opening 623. The film 650 is provided by a supply roller 655. A first sealing device 660 seals opposing vertical edges 652 and 654 of the film 650. A second sealing device 670 seals the other seams. A cutting device 680 separates the individual packets 50 and drops the packets 50 onto a take-away conveyor 690.

The lasers 605a and 605b may be integrated with the packet forming assembly 600 in any of a variety of configurations or positions. Although FIG. 10 shows the use of multiple lasers, only one of the lasers 605a and 605b needs to be employed. The lasers 605a and 605b may form openings 91 in the packets 55 at a pre-fill stage or a post-fill stage in the packet forming process. For example, the laser 605a may form the openings 91 in the film 650 before the film 650 reaches the horn 620. For example, the laser 605b may form the openings 91 in the packets 55 on the take-away conveyor 690. The laser 605b may be positioned directly over the take-away conveyor 690.

The systems 500 and 600 may also include the controller 420 to program and/or modulate any of a number of parameters and attributes of the laser pulses. The systems 500 and 600 may also include the encoder 430 to register and time the pulses from the lasers to strike the films or packets at the appropriate interval and time.

What is claimed is:

1. A system to form openings in water soluble packets, comprising:
a packet forming assembly to form water soluble packets, the packet forming assembly includes one or more cavities, a base film supply roll supplies a base film to cover the one or more cavities, a feed hopper meters an amount of a product into the one or more cavities over the base film, and a lid film supply roll supplies a lid film that is sealed to the base film; and,
a laser to form one or more openings in the water soluble packets.

2. The system according to claim 1, wherein the laser forms the one or more openings in the base film of the water soluble packets.

3. The system according to claim 1, wherein the laser forms the one or more openings in the lid film of the water soluble packets.

4. The system according to claim 1, wherein the laser forms the one or more openings directly in the water soluble packets filled with the product.

5. The system according to claim 1, wherein the packet forming assembly is a rotary drum machine.

6. The system according to claim 1, wherein the packet forming assembly is a horizontal form fill seal machine.

7. The system according to claim 1, wherein the product is a powder detergent or a granule detergent.

8. The system according to claim 1, further comprising a controller to control pulses from the laser.

9. The system according to claim 8, further comprising an encoder, wherein the encoder measures or senses a movement of the water soluble packets, a drum, a film, or conveyor in order to register the pulses of the laser with the water soluble packets or film.

10. A system to form openings in water soluble packets, comprising:
a rotating drum operatively engaged to a motor for rotating the drum;
the drum comprising one or more of cavities;
a base film supply roll to supply a base film to the drum to cover the one or more cavities;
a feed hopper to meter an amount of a product into the one or more cavities over the base film;
a lid film supply roll to supply a lid film to the drum; and,
a laser to form openings in the base film, the lid film, or the water soluble packet.

11. The system according to claim 10, wherein the laser simultaneously pulses one or more rows of the cavities.

12. The system according to claim 10, wherein the cavities includes a vacuum opening that is in fluidic communication with a vacuum passage, and a vacuum assembly of the drum draws air through the vacuum opening.

13. The system according to claim 10, wherein the drum drops the water soluble packets onto a take away conveyor, and the laser is positioned proximate to the conveyor and pulses the water soluble packets on the conveyor.

14. A system to form openings in water soluble packets, comprising:
a vertical form fill seal machine to form water soluble packets, the vertical form fill seal machine includes a hopper, a horn, a supply of film, and one or more sealing devices, wherein the film is positioned about an exterior surface of the horn, the hopper meters an amount of a product into the horn, and the one or more sealing devices seal the film closed to form the water soluble packets; and,
a laser to form one or more openings in the water soluble packets.

15. A method of forming openings in water soluble packets, comprising:
providing a packet forming assembly to form water soluble packets, the packet forming assembly comprising one or more cavities;
covering the one or more cavities with a base film;
feeding an amount of a product into the one or more cavities over the base film;
sealing a lid film to the base film to form the water soluble packet; and,
forming openings in the water soluble packets with a laser.

16. A method of forming openings in water soluble packets, comprising:
drawing a base film into a cavity of a drum;
metering an amount of a product onto the base film in the cavity;
sealing a lid film to the base film; and,
forming openings in the water soluble packets with a laser.

17. The method according to claim 16, further comprising venting an interior of the water soluble packets through the openings.

18. The method according to claim 16, further comprising forming the openings in a lid film of the water soluble packets.

19. The method according to claim 16, further comprising forming the openings in a base film of the water soluble packets.

20. The method according to claim 16, further comprising forming the openings directly in the water soluble packets.

21. A method of forming water soluble packets, comprising:
drawing a base film into a cavity of a drum;
forming one or more openings in the base film with a laser;
vacuuming air through the openings in the base film;
metering an amount of a product onto the base film in the cavity;
vacuuming the product into the base film; and,
applying a lid film to the base film.

22. The method according to claim 21, further comprising increasing a density of the product in the base film by the vacuuming.

23. A laser assembly to form openings in water soluble packets, comprising:
a laser; and,
a controller, wherein the controller modulates pulses from the laser to direct the pulses at water soluble packets or a film forming water soluble packets.

24. The laser assembly according to claim 23, further comprising an encoder, wherein the encoder is in electrical communication with the controller, and the encoder registers the laser with the water soluble packets or the film that forms the water soluble packets.
